(19) United States
(12) Patent Application Publication
(10) Pub. No.: US 2009/0004462 A1
(43) Pub. Date: Jan. 1, 2009

(54) Inorganic-Organic Hybrid Nanocomposite Antiglare and Antireflection Coatings

(75) Inventors: Ruiyun Zhang, York, PA (US); Xiaodong Wu, Lancaster, PA (US); Jin-Ming Yang, Bethesda, MD (US)

Correspondence Address: JONES DAY, 222 EAST 41ST ST, NEW YORK, NY, 10017, US

(73) Assignee: Optimax Technology Corporation, Ping Chen (TW)

(21) Appl. No.: 11/884,870

(22) PCT Filed: Feb. 23, 2006
(86) PCT No.: PCT/US06/06239

§ 371 Date: Jul. 25, 2008

Related U.S. Application Data
(60) Provisional application No. 60/656,096, filed on Feb. 25, 2005.

(51) Int. Cl. B32B 5/16; B32B 27/06; C08K 9/10

(52) U.S. Cl. 428/331; 428/412; 428/452; 428/446; 428/428; 523/209; 977/773

(57) ABSTRACT

Embodiments of this disclosure relate to compositions, and a method of making UV or heat curable anti-reflection and anti-glare hard coatings. Such coatings may be useful, for example, for simultaneously improving transmission and preventing undesired visible reflection on various monitor or display panels and optical lenses. For the panels with plastic covers, the coating will also improve the surface mechanical properties such as abrasion and scratch resistance.

### CROSS-REFERENCE TO RELATED APPLICATION

This application claims benefit of U.S. Provisional Application No. 60/656,096 filed Feb. 25, 2005. This application, in its entirety, is incorporated herein by reference.

### BACKGROUND OF THE INVENTION

With a tremendous surge in the use of hand-held telecommunication or computerized apparatuses such as cellular phones, palm devices or portable on-line tools, their respective display devices must pass much harsher quality and endurance tests commensurate to their use in an outdoor environment. Consequently, their top functional coating, whether for the purpose of improving the image quality or protecting the device surface, must be significantly upgraded to meet new challenges.

Compared with a desk-top unit, these smaller devices, including laptop computers, are more likely to be operated under a less controllable lighting environment. The reflection of the external lighting from the top surface of a display, even though representing only a small percentage (e.g., 4˜8%) of the total incident intensity, could still be too bright to achieve a desirable display quality. The detrimental effects from surface reflections, whether it is attributed to a reduced contrast ratio or an interfering image of an external object, are highly undesirable, and must be minimized. One effective treatment is to minimize the specular reflection from a top surface either by reducing its intensity (i.e. antireflection (AR) treatment) or by substantially diffusing the directions of the colligated reflection beam (i.e. antiglare (AG) treatment).

Because the largest change in refractive index occurs at the interface between air (n˜1) and the substrate (n˜1.5), an effective AR or AG coating of a display substrate must be present at the topmost layer, i.e. in direct contact with the air. Likewise, the top layer should preferably have a hard coating layer that provides abrasion and scratch resistance to the display device. Thus, the AR or AG function is preferably to be built with the hard coating at the topmost layer of a display device. The simplest approach, so far, is by adding either inorganic particles or polymer beads within a hard coating formulation so that its surface is roughened just enough to diffuse the specular reflection (an AG hard coating).

An AR coating is generally more sophisticated than an AG coating. It would normally require creation of a precisely controlled multilayer structure that could engage reflections from each interface to a destructive interference in the viewing direction. Such a multi-layered AR coating must have a prescribed combination of refractive index variations as well as layer thickness in order to achieve the desired destructive interference over an entire visible spectrum. Furthermore, for achieving such a destructive interference, each layer's thickness must be controlled within the precision of several to ten nanometers; making its production (normally by a vapor deposition process) much more difficult and more expensive than that achievable by an ordinary coating process.

While a multi-layered AR coating by vapor deposition is effective in reducing reflection intensity, it is not effective due to the flatness of the top surface in diffusing the (reduced) specular reflection. When used under bright outdoor lighting conditions, an AR coating, unless able to achieve 100% reduction in reflection across the whole visible spectrum, may still show a weak and sometimes even colored image of a bright external object. Thus, for a display device to be used under various external lighting environments, a top coating with a combined AR and AG functions would be more desirable and of a higher commercial value.

Anti-marring properties of the coating is another critical issue for display monitor panel or optical lenses applications. The coating must have good abrasion and scratch resistance, chemical resistance and also weathering resistance for outdoor use. That means the outmost layer of the coating must be mechanically strong and stable enough for its applications over time. A majority of prior art anti-reflection coatings and especially broadband AR-coatings that are based on graded refractive index emanating from a porous surface structure (U.S. Pat. No. 6,177,131; Nature, 410, 796-799(2001); Science, 283, 520-522 (1999)) or moth eye-like structure (Nature, 244, 281-282 (1973); Optica Acta, vol. 29, No. 7, 993 (1982); DE 19708776 (1998)), have the same problem in that the coating surface is not durable and is easily abraded or scratched. Synthetic organic polymer coatings based upon acrylic or terephthalate resins have generally good optical properties, but have their limits as hard coating to prevent abrasion or scratch marring. Inorganic coatings produced by gas phase or vacuum deposition (CVD, PVD), have relatively good abrasion or scratch resistance, but they are expensive to manufacture and the adhesion between the coating layer and substrate is often poor because of the different thermal expansion coefficients of the coating and the substrate. Some hybrid coating compositions based on UV-curable or heat-curable resin and inorganic particles have been developed and offered good abrasion and scratch resistance. (U.S. Pat. No. 4,239,798; U.S. Pat. No. 4,348,462; U.S. Pat. No. 5,712,325; Thin Solid Films, 351, 216-219 (1999)).

### SUMMARY OF THE INVENTION

We disclose a coating composition, which comprises a functionalized silica sol containing both silanol groups and polymerizable moieties such as acrylic, vinyl or epoxy groups. According to a particular embodiment of the invention, there is provided a composition suitable for forming a durable optical functional coating comprising a hybrid nanocomposite comprising surface modified silica nanoparticles and functionalized silica sols containing both silanol groups and polymerizable organic moieties, with or without additional organic monomer(s). The silica nanoparticles preferably have an at least substantially spherical shape with controlled particle size in the range of, for example, from about 20 nm to about 600 nm. In an embodiment of the invention, the silica nanoparticles may be prepared by a modified Stöber process, such as described more fully below. In addition to condensation of silanol to form siloxane bonds (Si—O—Si), the polymerizable groups chemically connected to the silicon atoms can be further cured with UV-radiation or application of heat and then polymerized into a highly crosslinked network. The resultant inorganic-organic network offers good hardness and anti-marring properties. Additional di- and/or multi-functional monomers or oligomers can also be added to adjust the optical or mechanical properties. In an embodiment of this invention, a coating composition, contains fluorocarbon surface modified silica (F-silica) particles with very low surface tension. This specific silica particle may also be prepared based on a modified Stöber process, such as described more fully below.

According to another embodiment of the invention, there is provided, an antiglare and antireflection dual function (AGAR) optical material comprising a coating layer of a composition suitable for forming a durable optical functional coating comprising a hybrid nanocomposite comprising surface modified silica nanoparticles and functionalized silica sols containing both silanol groups and polymerizable organic moieties, with or without additional organic monomer, applied on one or both sides of a transparent substrate. In a particular embodiment of the AGAR optical material the coating layer comprises a dry cured film obtained from a solution comprising silica nanoparticles, the size and surface functionality of which are controlled by a modified Stöber reaction; a silica sol prepared by the hydrolyzation of a tetraalkoxy silane in an acidic media; and a photoinitiator. In another embodiment of the AGAR optical material the transparent substrate comprises a plastic substrate or a glass substrate.

In accordance with an embodiment of the compositions of the present invention as described above, the silica sol may be the reaction product of tetraalkoxy silane and organic functional silane agent in an acidic media, representative examples of which include organic acids, such as acetic acid and inorganic acids, such as hydrochloric acid, sulfuric acid, nitric acid. In a particular embodiment, the organic functional group of the organic functional silane agent may be, for example, vinyl, acryloxy, methacryloxy, epoxy, etc. In one embodiment of the invention, the refractive index of the silica sol may be adjusted by reacting it with a fluoroalkoxy silane agent in an acidic media, e.g., acetic acid, hydrochloric acid, etc.

According to another aspect of the present invention, the coating compositions and the AGAR optical materials may be used in a display device or in an optical device or in a telecommunications device.

### DETAILED DESCRIPTION AND PREFERRED EMBODIMENTS

In one embodiment, the present anti-reflection coating containing F-silica particles and inorganic-organic hybrid matrix is based on a simple self-assembly process and the coating components can be cured subsequently by heat, UV-radiation, or both together.

In one embodiment, the process starts with a homogeneous suspension of F-silica particles, soluble functionalized silica sol, dispersing agent, organic monomer/oligomer, and initiator prepared in lower alcohols. The coating may be applied to the substrate using well known techniques such as reverse roll coating, wire-wound rod and dip coating methods. During the coating application procedure, preferential evaporation of the alcohol progressively enriches the non-volatile coating compositions on the depositing substrate. The dispersed fluorocarbon surface modified silica particles, because of their low-energy surface, migrate to the surface of the coating layer, which leads to the lowest system energy of the coating layer. When fluorinated silica particle concentration is high enough, the accumulated particles completely cover the surface of the coating, and form a coating layer with a gradient refractive index, as described in commonly assigned, co-pending application Ser. No. 10/514,018, filed Nov. 10, 2004 and published Apr. 1, 2004, under WO2004/027517, the entire disclosures of which are incorporated herein in their entirety by reference thereto, and which enhances the anti-reflection effect. At the same time, some of F-silica particles aggregate to form particle clusters with domain size at the same length scale as the wavelength of the visible light. The particle clusters on the coating surface scatter the reflected light and then offer antiglare effectiveness.

Fluorocarbon surface modified silica particles (F-silica) may be made by a modified Stöber process of which the starting silica source is a mixture of alkoxysilane and fluoroalkoxysilane. Silica particles may be grown using the Stöber process, described in Werner Stober, Arthur Fink, and Ernst Bohn, J. Colloid and Interface Science 26, 62-69 (1968), hereby incorporated herein by reference. In one embodiment, fluoroalkoxysilane is used with alkoxysilane to provide surface modification of the silica particles. According to a preferred embodiment, tetraethylorthosilicate (TEOS), (tridecafluoro-1,1,2,2-tetrahydrooctyl)triethoxysilane (F-TEOS), ammonium hydroxide (NH₄OH), and water are added to a glass beaker containing reaction medium. The resulting F-silica particles are obtained by stirring the mixture for a certain period of time. The size of the particles is controlled by the amount of ammonium hydroxide and water added. FIG. 1 is a graphic illustration of this reaction (Scheme 1). In one embodiment, the reaction medium is isopropanol and the catalyst is ammonium hydroxide. The reaction begins when all the above starting materials and water are added in isopropanol, or other suitable reaction medium. The particle size from this process was measured by light scattering (90 Plus Particle Size Analyzer, Brookhaven Instruments Corporation). The medium for particle sizing was ethanol. Generally, the silica nanoparticles as well as the F-silica particles with particle size in the range of 20 nm to 600 nm, such as 80 nm to 400 nm, in particular, 150 nm to 250 nm, may be prepared. The fluorocarbon content in the particles is calculated based on the molar ratios of the reactants. In certain embodiments, the fluorocarbon content of the particle used in the coating compositions is in the range of 10 to 30% based on the molar ratio. The fluorine atoms can significantly reduce the surface free energy and the refractive index of the particles. The particles can be dispersed homogenously in, for example, isopropanol.

The functionalized silica sol may be prepared by using a mixture of tetraalkoxysilane and alkyl-alkoxysilane as starting compounds. The general formula of the tetraalkoxysilane is SiX₄, in which the chemical moiety X represents one or more hydrolysable groups. The general formula of the functional group containing silane is R¹ₙR²ₘSiX₍₄₋ₙ₋ₘ₎, in which R¹ and R² are the same or different, non-hydrolyzable chemical moieties with or without a functional group. In the above formula, n and m are each numbers from 0 to 3, and the sum n+m≦3. Examples of the hydrolysable moiety X include, for example, halogen, alkoxy and alkylcarbonyl. An alkoxy with low molecular weight, such as methoxy, ethoxy, n-propoxy, i-propoxy, and/or butoxy is preferably used. The functional groups on the moiety R₁ or R₂ include, for example, polymerizable groups, such as vinyl, acryloxy, methacryloxy and epoxy. Representative examples of functional alkyl-alkoxysilanes include:

CH₂═CH—Si(OCH₃)₃; CH₂═CH—Si(OCH₂CH₃)₃;

CH₂═CH—CH₂—Si(OCH₃)₃; CH₂═CH—CH₂Si(OCH₂CH₃)₃;

CH₂═C(CH₃)—COO—C₃H₇—Si(OCH₃)₃; CH₂═C(CH₃)—COO—C₃H₇Si(OCH₂CH₃)₃;

CH₂═CH—COO—C₃H₇—Si(OCH₃)₃; CH₂═CH—COO—C₃H₇Si(OCH₂CH₃)₃;

CH₂—CHO—CH₃C₃—Si(OCH₃)₃; CH₂—CHO—C₃H₇—Si(OCH₂CH₃)₃;

CH₂═CH—COO—C₃H₇—SiCH₃(OCH₃)₂; CH₂═CH—COO—C₃H₇SiCH₃(OCH₂CH₃)₂;

CH₂—CHO—CH₃C₃H₇—SiCH₃(OCH₃)₂; CH₂—CHO—C₃H₇—SiCH₃(OCH₂CH₃)₂.

The molar ratio of tetraalkoxysilane to functional alkyltrialkoxysilane in stock mixture may generally fall within the range 95:5 to 40:60, such as, 90:10 to 60:40. Other hydrolytically condensable organometallic species of Al, Ti, and Zr can also be used to replace tetraalkoxysilane as a starting material. The basic chemistry of formation of the organic moiety containing silica sol is hydrolysis and condensation of silanes. In a typical reaction condition, hydrolysis and partial condensation of the silanes leads to formation of organic modified silica oligomer as shown in scheme 2 (see FIG. 2). Both silanol group and functional group on the silica oligomer are active at a certain condition and then can be polymerized into a highly crosslinked hybrid network.

The hydrolysis and partial condensation of organic metal compounds with water may be performed in an organic medium. The reaction medium may be an acidic mixture with lower alcohols such as methanol, ethanol, propanol, isopropanol or butanol as a major component. Diluted hydrochloric acid (HCl) may be used as catalyst for the hydrolysis and condensation of the silanes. In one embodiment, a certain amount of TEOS and methacryloxypropyl-trimethoxysilane are added into a container having a certain amount of isopropanol, then accurately measured 0.2M HCl in water is added under constant stirring at room temperature. The mixture is stirred for an additional 6 hours with the solution. The mixture is then aged in the quiescent state at room temperature for an additional 24 hours. The polymerizable organic moiety content in the silica sol depends on the molar ratio of the starting compounds. The concentration of the functional silica sol can be controlled by adjusting the amount of alcohol added. The functional silica sols are also found miscible with a wide range of acrylate monomers and acrylate derived oligomers at different molar ratio.

In another embodiment, the functional silica sol is prepared by introducing the functionalized silane directly into a F-silica particle suspension. In this procedure, the silane may be added into the F-silica suspension after the freshly prepared particles have been aged for about 2 hours. The silane hydrolyzes and partially condenses with the F-silica sol. Some of functionalized silica sol reacts with silanol groups on the surface of F-silica particles and modifies the particles in situ. No extra acidic or basic catalyst needs to be added during this process. The F-silica particle suspension containing the functional sol can be used without modification as an AGAR coating base. In other cases, extra silica sol or organic components need to be added in order to obtain coatings with satisfactory mechanical properties.

Under normal storage condition, the sol prepared using the acid catalyzed procedure is stable over time when the pH of the silica sol and the organic functionalized silica sol is maintained over a certain range. For example, in one embodiment, the normal condition is to keep the sol solution away from strong light and heat. Generally, when the pH of the sol is lower than 2 and the part of silica connected to organic moiety is higher than 20% (molar ratio), under such storage condition, at the end of several weeks after preparation of the product, there is still a clear and transparent solution without sedimentation and gel. No appearance of haze is noted either.

The functionalized silica sol can be used as the binder or matrix in the present AGAR coating compositions. The silica sol acts as both binder for the F-silica particles and hard coating matrix after being cured. The primary silica entity in the sol is partially condensed silica oligomer. Representative chemical structures of the oligomers are shown in FIG. 2 for Scheme 2. Besides organic functional groups, a large amount of silanol groups exist on the silica oligomer. These silanol groups will further react with each other or with other functional groups under appropriate conditions to form a crosslinked network. In embodiments of the present invention, the F-silica particle is another desired component in the coating composition. After the evaporation of solvent, the coating layer with the structure as shown in FIG. 3 (Scheme 3) automatically forms on the substrate as the result of self-assembly of coating components. In this embodiment, the surface of the F-silica particle has been modified with fluoroalkyl group(s). However, there are generally still a large number of silanol groups remaining on the particle surface. The subsequent condensation of these silanol groups on the F-silica particle with the silanol group on silica oligomer will chemically link the F-silica particle to the organic silica sol. After curing with UV-radiation or heat, the organic silica sol becomes the coating matrix. The chemical bonding between F-silica particles with the coating matrix will significantly increase the mechanical properties of the coating.

In embodiments of the invention, the functionalized silica sol can also be used as one of components of the coating composition to form the coating matrix. Other components include, for example, polymerizable organic monomers or oligomers with di- or multi-functional groups. For a coating system containing both the silica sol and polymerizable organic species, the coating with a structure such as shown in FIG. 4 (Scheme 4) forms on the substrate after evaporation of solvent in the applied coating mixture. Based on the combination of the silica sol and organic resin, there is a wide range of organic monomers or oligomers that can be chosen to match the properties between the substrate and coating. By using different substrates, the practitioner may readily determine the appropriate organic monomer(s) or oligomer(s) to achieve the desired properties. In the coating composition according to various embodiments of the invention, the silica sol functions to bridge F-silica particles and coating matrix as shown in FIG. 4 (Scheme 4). The coating matrix, in this embodiment of the invention, is a hybrid composite based on functional silica sol and the organic monomer(s) and/or oligomer(s) chosen.

As described above, part of the matrix phase of the coating can be organic components. In order to facilitate migration of the F-silica particles during the application of the coating mixture onto the substrate, the viscosity of the coating mixture should be sufficiently low to facilitate particle movement. For example, a viscosity in the range of from about 1 to about 50 cSt may be conveniently selected. Accordingly, a monomer, a low molecular weight oligomer or a combination of both is preferably chosen to provide the coating solution with a relatively low viscosity. These organic monomer(s) and/or oligomer(s), containing one or several polymerizable groups, can be thermally or photochemically induced to polymerize into crosslinked polymer networks, preferably co-polymerizing with the functionalized silica sol to form highly crosslinked organic-inorganic hybrid networks. Specific examples of these monomers and/or oligomers in the coating mixture include methyl acrylates and their derivatives with di- or multi-functional groups (e.g. carbon double bond).

The solvent should generally be chosen to be able to homogeneously disperse fluorocarbon modified silica particles and dissolve the necessary coating base such as modified silica sol and organic monomer(s) and/or oligomer(s). The coating mixture containing solvent and all coating components having suitable viscosity, (e.g., in the range of from about 1 to about 50 cSt) is applied to the substrate according to the coating processing method. No phase separation should occur before or after application of the mixture to the substrate. Generally, alcohols with lower molecular weight, such as methanol, ethanol, propanol, and butanol, in particular, iso-propanol or ethanol, are used in the coating compositions. Other low molecular weight solvents (e.g., with a total carbon number of 4 or less) which will not interfere with the reaction may also be used.

In order to enhance the dispersion of the fluorinated silica in the coating mixture, one or more dispersion agent(s) may be added to the coating mixture. Generally, cationic surfactants and/or non-ionic surfactants can be used. For example, dimethyl-dioctadecylammonium bromide (DDAB), Brij 76 or PN-9 may be used as dispersion agents in these coating systems.

The coating mixture, according to embodiments of the present invention, may contain a catalyst for thermally and/or photochemically induced curing of the coating matrix. Thermal initiators used include, for example, organic peroxides, such as dialkyl peroxides, diacyl peroxides and alkyl hydroperoxides. Photoinitiators, such as 1-hydroxycyclohexyl phenyl ketone, benzophenone, 2-isopropyl thioxanthone may be used for the coating composition which can be cured with UV-radiation. Cationic photoinitiators such as iodonium and sulfonium salts of hexafluoroantimonic acids are used to initiate the UV curing of functional sol containing epoxy moiety. The initiator amount added is based on the coating compositions and generally may be in the range of 1 wt % to 5 wt % based on solid content of the coating mixture. The coating can also be cured with electron-beam radiation without the use of initiators.

The coating mixture may be applied onto an appropriate substrate with any suitable coating application method. For example, conventional coating methods, such as dipping and flowing, roll, spinning, spraying or brushing can be employed with the coating compositions. The applied coating composition is preferably dried before curing. The drying temperature is preferably at the range of about 50° C. to about 150° C. depending on the substrate used. Preferred coating thickness after curing range from about 0.1 to about 3 microns. The preferred substrates are plastics, e.g., acrylic polymers, cellulosic polymers (such as, for example, triacetyl cellulose), polycarbonates, polyesters (e.g., polyethylene terephthalate); glasses (e.g., BK-7 glass, float glass, tempered glass) and ceramics. Mixtures of two or more transparent polymers may also be used. Composite substrates, such as laminates of plastic and glass, etc., may also be used. For display monitor panel applications, transparent plastics or plastic film such as polycarbonate, polymethyl methacrylate, polyethylene terephthalate and triacetate cellulose film are of particular interest based on the current state of the art; however, other transparent or non-transparent or translucent substrates may also be coated with the compositions according to the various embodiments of the present invention.

### BRIEF DESCRIPTION OF THE DRAWING FIGURES

FIG. 1 is a reaction diagram illustrating the preparation of fluorinated silica particle by a modified Stöber process with alcohol as reaction medium and ammonium hydroxide as a catalyst according to an embodiment of the present invention.

FIG. 2 is a reaction diagram illustrating the hydrolysis and partial condensation of alkoxysilanes to form a functionalized silica sol according to another embodiment of the present invention.

FIG. 3 is a schematic illustration of the composition of a curable coating layer after solvent evaporation according to an embodiment of the invention. The coating system contains fluorinated silica particles and functionalized silica sol.

FIG. 4 is a schematic illustration of the composition of a curable coating layer after solvent evaporation according to another embodiment of the invention. The coating system contains fluorinated silica particle, functionalized silica sol, and polymerizable organic species.

FIG. 5 is a graphical presentation of the reflection spectrum of the AGAR coating of Example 11 shown as a function of reflection (%) versus wavelength (nm).

FIG. 6 is a graphical presentation of the reflection spectrum of the AGAR coating of Example 12 shown as a function of reflection (%) versus wavelength (nm).

FIG. 7 is a graphical presentation of the reflection spectrum of the AGAR coating of Example 13 shown as a function of reflection (%) versus wavelength (nm).

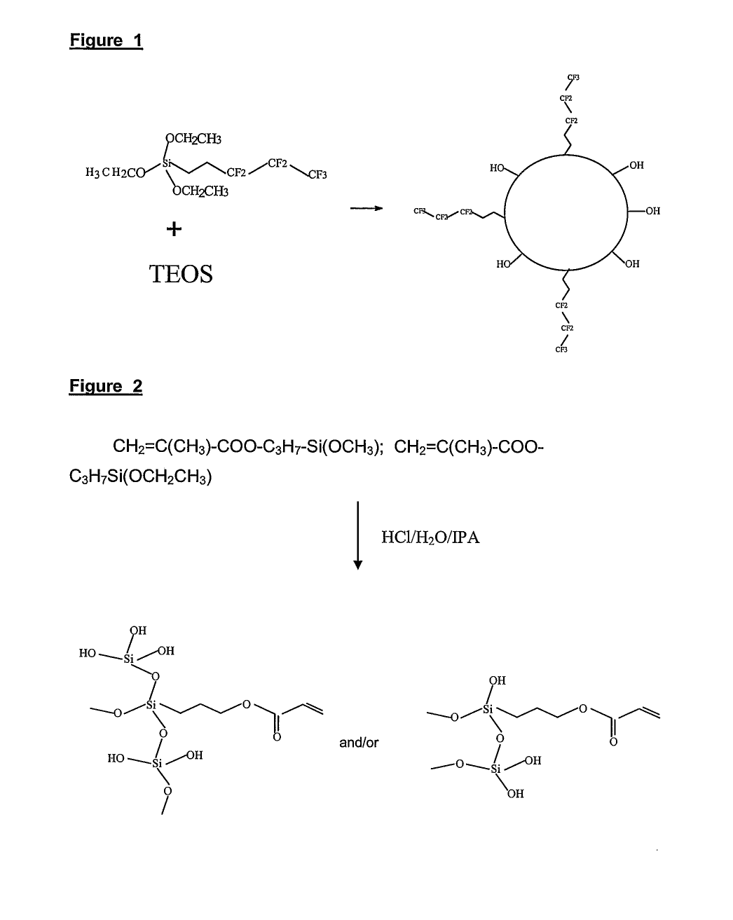

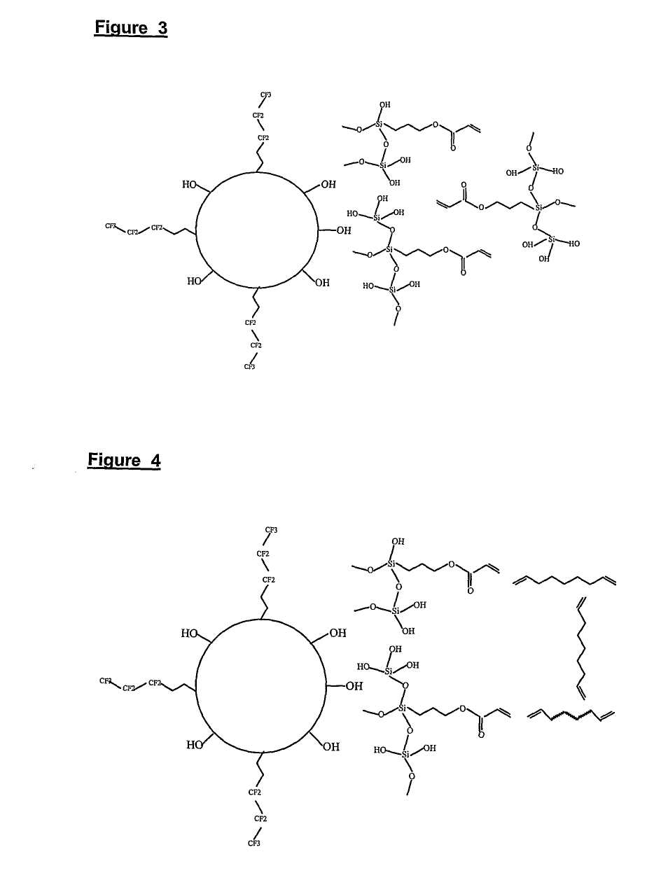

### EXAMPLES

### Example 1 and Example 2

### Preparation of Fluorocarbon Modified Silica Particles

### Example 1

In a reaction vial, 100 ml isopropanol (IPA), 14 ml tetraethoxysilane (TEOS) and 6 ml tridecafluoro-1,1,2,2-tetrahydrooctyl)triethoxysilane (F-TEOS) were added and mixed with a magnetic stirrer at a high speed for two minutes. While stirring, 7.5 ml deionized water and 5 ml concentrated ammonia solution (NH₃ 28-30 wt % in water) were added into the mixture. The mixture was stirred over a period of 30 to 240 minutes. The initially clear mixture became a translucent suspension. The suspension was aged for two days and then the particle size was determined by laser light scattering. The medium for particle sizing was ethanol. The particle suspensions were treated by ultrasound for 5 to 10 minutes before particle sizing. The fluoro-content in the particles was calculated based on the molar ratios of the reactants.

The average particle diameter prepared from above procedure is about 120 nm. The molar ratio of F-containing silica to pure silica in the particles is 20:80.

### Example 2

In a reaction vial, 100 ml isopropanol, 14 ml TEOS and 6 ml F-TEOS were added and mixed with a magnetic stirrer at a high speed for two minutes. During the stirring, 14.5 ml of deionized water and 5 ml concentrated ammonium hydroxide solution (NH₃ 28-30 wt %) were added to the mixture. The mixture was stirred over a period of 30 to 240 minutes. The initially clear mixture develops into an opaque white suspension. The suspension was subsequently aged for two days and then the particle size was determined by laser light scattering. The particle size is around 250 nm. The molar ratio of F-containing silica to pure silica in the particles is 20:80.

### Example 3 to Example 8

### Functionalized Silica Sol

### Example 3

In a reaction vial, 50 ml IPA, 15 ml TEOS and 1.8 ml methacryloxy propyl trimethoxysilane (MA-TMOS) were added and mixed with a magnetic stirrer for several minutes. During the stirring, 5.5 ml of 0.2 M HCl/H₂O was added into the mixture. The pH of the mixture was about 1.5. The mixture was stirred for two hours at room temperature. A clear solution was obtained. The solution was aged for at least one day before being used in a coating formulation. The acrylate content in the silica sol was calculated based on the molar ratios of the reactants. In this case, the molar ratio composition of the acrylate is 10%.

### Example 4

In a reaction vial, 50 ml IPA, 15 ml TEOS and 6.8 ml MA-TMOS were added and mixed with a magnetic stirrer for several minutes. During the stirring, 8 ml 0.2 M HCl/H₂O was added into the mixture. The pH of the mixture was around 1.5. The mixture was then stirred for two hours at room temperature. A clear solution was obtained. The solution was then aged for a minimum of one day before being used in the coating formulation. The molar ratio of the acrylate is about 30%.

### Example 5

In a reaction vial, 50 ml IPA, 15 ml TEOS and 10.3 ml vinyl trimethoxysilane were added and mixed with a magnetic stirrer for several minutes. During the stirring, 9.7 ml 0.2 M HCl/H₂O was added into the mixture. The mixture was then stirred for two hours at room temperature. A clear solution was obtained. The solution was then aged for a minimum of one day before being used in the coating formulation. The molar ratio composition of the vinyl is about 50%.

### Example 6

In a reaction vial, 50 ml IPA, 7 ml TEOS and 0.37 ml (3-Glycidoxypropyl) trimethoxysilane (G-TMOS) were added and mixed with a magnetic stirrer for several minutes. During the stirring, 5 ml 0.2 M HCl/H₂O was added into the mixture. The mixture was then stirred for two hours at room temperature. A clear solution was obtained. The solution was then aged for a minimum of one day before being used in the coating formulation. The epoxy content in the silica sol was calculated based on the molar ratios of the reactants. In this case, the molar ratio composition of the epoxy is about 5%.

### Example 7

In a reaction vial, 50 ml IPA, 7.5 ml TEOS, 3.18 ml F-TEOS and 0.22 ml (3-Glycidoxypropyl) trimethoxysilane (G-TMOS) were added and mixed with a magnetic stirrer for several minutes. During the stirring, 5.5 ml 0.2 M HCl/H₂O was added into the mixture. The mixture was then stirred for two hours at room temperature. A clear solution was obtained. The solution was then aged for a minimum of one day before being used in the coating formulation. The epoxy content in the silica sol was calculated based on the molar ratios of the reactants. In this case, the molar ratio composition of the epoxy is 3%.

### Example 8

In a reaction vial, 50 ml IPA and 7.5 ml TEOS were added and mixed with a magnetic stirrer for several minutes. During the stirring, 5 ml 0.2 M HCl/H₂O was added into the mixture. The mixture was then stirred for two hours at room temperature. A clear solution was obtained. The solution was then aged for a minimum of one day before being used in the coating formulation.

### Examples 9 and 10

### Functionalized Silica Sol Directly Formed in F-Silica Particle Suspension

### Example 9

In a reaction vial, 100 ml IPA, 14 ml TEOS and 6 ml F-TEOS were added and mixed with a magnetic stirrer at a high speed for two minutes. During the stirring, a volume between 0.5 and 20 ml deionized water and a volume between 0.5 and 20 ml concentrated NH₃/H₂O solution (NH₃ 28-30 wt %) were added to the mixture. The mixture was stirred 30 to 240 minutes. The clear mixture would develop into white suspension. The suspension was aged for 2.5 hours and then 0.9 g MA-TMOS was added to the suspension. The suspension stirred for 10 minutes and then aged for a minimum of two days before being used in the coating formulation. The acrylate content in the silica particle suspension was calculated based on the molar ratios of the TEOS and MA-TMOS. In this case, the molar ratio composition of the acrylate is about 5%. The particle size is around 160 nm. The molar ratio of F-containing silica to pure silica in the particles is 20:80.

### Example 10

In a reaction vial, 100 ml IPA, 14 ml TEOS and 6 ml F-TEOS were added and mixed with a magnetic stirrer at a high speed for two minutes. During the stirring, a volume between 0.5 and 20 ml deionized water and a volume between 0.5 and 20 ml concentrated NH₃/H₂O solution (NH₃ 28-30 wt %) were added into the mixture. The mixture was stirred 30 to 240 minutes. The clear mixture would develop into white suspension. The suspension was aged for 2.5 hours and then 0.89 g (3-glycidoxypropyl) trimethoxysilane (G-TMOS) was added to the suspension. This mixture was stirred for an additional 10 minutes and then aged for two days before being used in the coating formulation. The epoxy content in the silica particle suspension was calculated based on the molar ratios of the TEOS and G-TMOS. In this case, the molar ratio composition of the epoxy is 5%. The particle size is around 160 nm. The molar ratio of F-containing silica to pure silica in the particles is 20:80.

### Example 11 to Example 15

### AGAR Coating Formulations

This is a typical procedure for producing the coating: In a container, a certain amount of F-silica particle IPA suspension and dispersion agent (surfactant) are added and mixed. Then functionalized silica sol, organic monomer and/or oligomer, and photo-initiator, dissolved in the IPA are added. The mixture is stirred and then sonicated in a ultrasonic bath for 5 minutes. After sonication, the mixture is ready for use. The coating mixture is applied onto a TAC film substrate by manually using coating bar (Meyer 8# or Meyer 12#). The TAC film with the wet coating is transferred to an oven at 70° C. for 3 minutes. The dried coating is then transferred to a UV-curing machine to be cured with a conveyor speed 25 fpm and radiation 300 WPI. The coating optical properties such as haze, gloss, reflection, and clarity are evaluated according to the regular evaluation standards for anti-glare and antireflection coatings. The haze is measured with Nippon-Denshoku NDH-2000 instrument. The gloss is measured with Nippon-Denshoku VG-2000 gloss meter. Reflection is measured with Hitachi U-4001 Reflection meter. Clarity is measured with Suga Test Instrument ICM-1T.

### Example 11

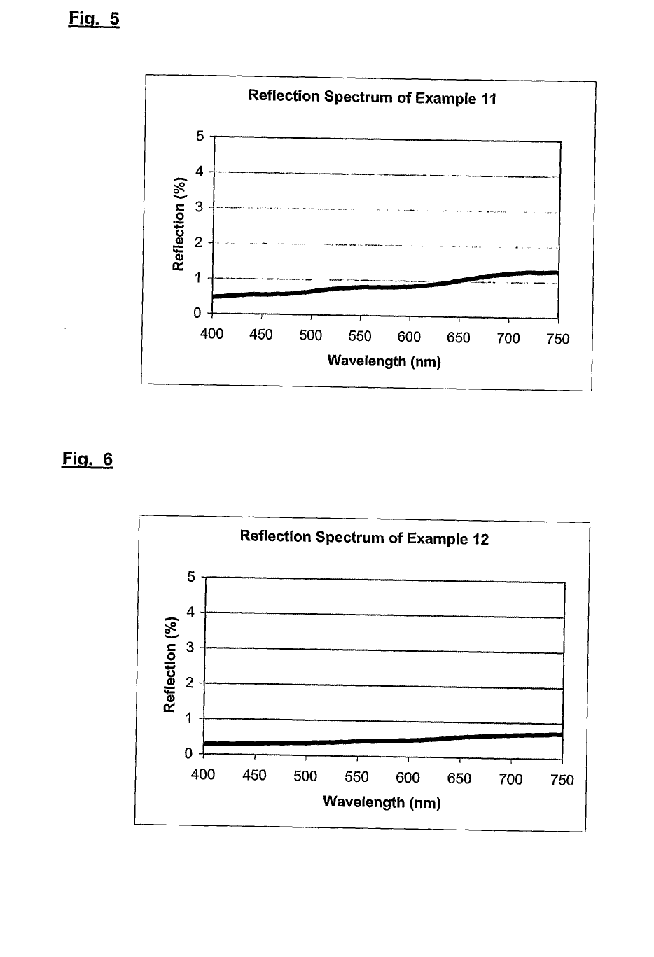

To 5.0 g of F-silica particle IPA suspension from example 2 (solid content˜10 wt %), 0.175 g 10% NP-9/IPA solution was added. (NP-9 is nonionic surfactant Tergitol with structure as C₉H₁₉C₆H₄(OCH₂CH₂)₉OH.). The suspension was mechanically shaken until the surfactant was homogeneously dispersed. To this mixture 5 g methacrylate modified silica sol (from example 3) containing 3% photo-initiator (Ciba Irgacure 184) was added. After stirring and sonication of this coating mixture, it was applied onto the TAC film with Meyer bar. The coating was dried at 70° C. and then cured with the UV-curing machine. The optical properties were measured and the results obtained are: Haze: 7.32; Gloss: 94.61; and clarity: 468.9. The reflection spectrum between 400 nm and 750 nm is shown in FIG. 5.

### Example 12

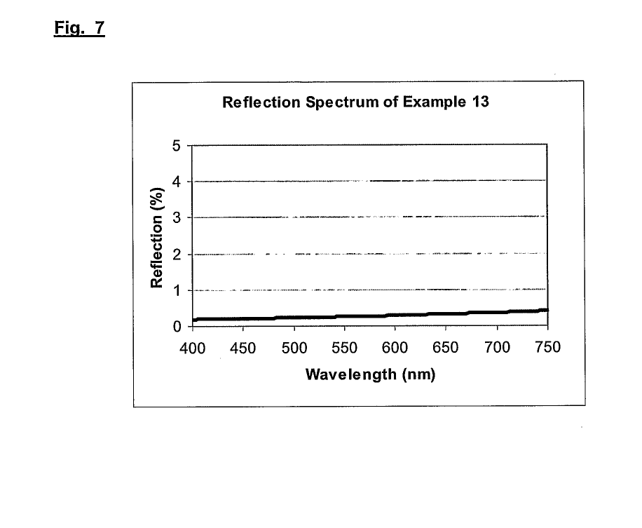

To 5.0 g of F-silica particle IPA suspension from example 2 (solid content˜10 wt %), 0.175 g 10% NP-9/IPA solution was added. The suspension was mechanically shaken until the surfactant was homogeneously dispersed. To this mixture 5 g methacrylate modified silica sol (from example 3) containing 3% photo-initiator (Ciba Irgacure 184) was added. This was followed by the addition of 0.75 g organic polymer coating base (Hexanediol diacrylate (UVHC8558, GE)/Multi-functional acrylate (KRM7039, Daicel-UCB=½, with 33 wt % IPA and 2 wt % Irgacure 184)). After stirring and sonication of this coating mixture, it was applied onto the TAC film with Meyer bar. The coating was dried at 70° C. and then cured with the UV-curing machine. The optical properties were measured and were: Haze: 15.72; Gloss: 59.49; and clarity: 459.7 The reflection spectrum between 400 nm and 750 nm is shown in FIG. 6.

### Example 13

To 5.0 g of F-silica particle IPA suspension from example 2 (solid content˜10 wt %), 0.175 g 10% NP-9/IPA solution was added. The suspension was mechanically shaken until the surfactant was homogeneously dispersed. To this mixture 5 g methacrylate modified silica sol (from example 3) containing 3% photo-initiator (Ciba Irgacure 184) was added. This was followed by the addition of 0.75 g organic polymer coating base (Hexanediol diacrylate (UVHC8558, GE)/Multi-functional acrylate (KRM7039, Daicel-UCB=½, with 33 wt % IPA and 2 wt % Irgacure 184). After stirring and sonication of this coating mixture, it was applied onto the TAC film with Meyer bar. The coating was dried at 70° C. and then cured with the UV-curing machine. The optical properties were measured and were: Haze: 18.93; Gloss: 43.85; and clarity: 447.3. The reflection spectrum between 400 nm and 750 nm is shown in FIG. 7.

### Example 14

To 1.0 g F-silica particle/MA-silica sol/IPA suspension from example 9 (solid content˜10 wt %), was added 4 g IPA and 0.5 g silica/IPA sol (example 8, solid content approximately˜15 wt %). After stirring and sonication of this coating mixture, it was applied onto an optical PMMA sheet with Meyer bar. The coating was dried at 70° C. and then cured with the UV-curing machine. The optical properties were measured and were: Haze: 2.0; reflection: 0.45%; transmission: 95.6% and clarity>450.

### Example 15

To 1.0 g F-silica particle/Epoxy-silica sol/IPA suspension from example 10 (solid content˜10 wt %), was added 4 g IPA and 0.5 g silica/IPA sol (solid content˜15 wt %). After stirring and sonication of this coating mixture, it was applied onto an optical PMMA sheet with Meyer bar. The coating was dried at 70° C. and then cured with the UV-curing machine. The optical properties were measured and were: Haze: 0.8; reflection: 0.5%; transmission: 96.0% and clarity>450.

### Example 16

To 1.0 g F-silica particle IPA suspension from Example 15 (solid content˜10 wt %), was added 4 g IPA and 0.3 g F silica/IPA sol from Example 7 (solid content˜5 wt %). After stirring and sonication of this coating mixture, it was applied onto the TAC film with Meyer bar. The coating was dried at 70° C. and then cured with the UV-curing machine.

What is claimed is:

1. A composition suitable for forming a durable optical functional coating comprising a hybrid nanocomposite comprising surface modified silica nanoparticles and functionalized silica sols containing both silanol groups and polymerizable organic moieties, with or without additional organic monomer(s).

2. An antiglare and antireflection dual function (AGAR) optical material comprising a coating layer of the composition according to claim 1 applied on one or both sides of a transparent substrate.

3. An AGAR optical material according to claim 2, wherein the coating layer comprises a dry cured film obtained from a solution comprising silica nanoparticles, the size and surface functionality of which are controlled by a modified Stöber reaction; a silica sol prepared by the hydrolyzation of an organic functional silane in an acidic media; and a photoinitiator.

4. An AGAR optical material according to claim 2, wherein the transparent substrate comprises a plastic substrate.

5. An AGAR optical material according to claim 4, wherein the plastic substrate comprises an acrylic polymer, triacetyl cellulose (TAC), polycarbonate (PC), or poly ethylene terephthalate (PET), or mixture of two or more thereof.

6. An AGAR optical material according to claim 2, wherein the transparent substrate comprises a glass substrate.

7. An AGAR optical material according to claim 2, wherein the silica sol is the reaction product of tetraalkoxy silane and organofunctional silane in an acidic media.

8. An AGAR optical material according to claim 7, wherein the acidic media comprises acetic acid, sulfuric acid, nitric acid or hydrochloric acid.

9. An AGAR optical material according to claim 7, wherein the organic functional groups of the organofunctional silane comprises at least one of vinyl, acryloxy, methacryloxy, or epoxy groups.

10. An AGAR optical material according to claim 2, wherein the refractive index of the silica sol is adjusted by reacting with a fluoroalkoxy silane agent in an acidic media.

11. An AGAR optical material according to claim 10, wherein the acidic media comprises acetic acid, sulfuric acid, nitric acid or hydrochloric acid.

12. An AGAR optical material according to claim 7, wherein the refractive index of the silica sol is adjusted by reacting with a fluoroalkoxy silane agent in an acidic media.

13. An AGAR optical material according to claim 12, wherein the acidic media comprises acetic acid, sulfuric acid, nitric acid or hydrochloric acid.

14. An AGAR optical material according to claim 2, wherein the silica nanoparticles have at least a substantially spherical shape with controlled particle size in the range of from 20 nm to 600 nm.

15. An AGAR optical material according to claim 14, wherein the silica nanoparticles are formed by a modified Stöber process.

16. An AGAR optical material according to claim 2, wherein the silica nanoparticles are surface modified with a fluoroalkoxy silane agent.

17. An AGAR optical material according to claim 16, wherein the surfaces of the silica nanoparticles are further modified with organic functional groups.

18. An AGAR optical material according to claim 17, wherein the organic functional groups comprise at least one of vinyl, acryloxy, methacryloxy, or epoxy groups effective to improve the mechanical properties of the coating layer.

19. An AGAR optical material according to claim 2, wherein the coating composition comprises a relatively low viscosity solvent.

20. An AGAR optical material according to claim 19, wherein the relatively low viscosity solvent comprises a low molecular weight alcohol.

21. An AGAR optical material according to claim 20, wherein the low molecular weight alcohol comprises methanol, ethanol, n-propanol, iso-propanol, n-butanol, or tert-butanol.

22. An AGAR optical material according to claim 20, wherein the low molecular weight alcohol comprises iso-propanol or ethanol.

23. An AGAR optical material according to claim 2, wherein the coating composition further comprises at least one dispersion agent.

24. An AGAR optical material according to claim 23, wherein the at least one dispersion agent comprises a cationic surfactant, a non-ionic surfactant, or mixture thereof, whereby aggregation of silica nanoparticles during application to the transparent substrate is effectively inhibited.

25. An AGAR optical material according to claim 2, wherein the coating composition is applied to the transparent substrate by roll coating, dip coating, spin coating or spray coating or any combination thereof.

26. A display device, having enhanced light transmission and/or reduction of glare from bright objects, comprising a durable functional optical coating according to claim 1.

27. A display device according to claim 26, which is an LCD display device.

28. A display device according to claim 26, which is a plasma display device.

29. An optical device, having enhanced light transmission and/or reduction of glare from bright objects, comprising a durable functional optical coating according to claim 1.

30. An optical device according to claim 29, which is a polarizer or an optical switch.

31. A telecommunications device, having enhanced light transmission and/or reduction of glare from bright objects, comprising a durable functional optical coating according to claim 1.

32. A telecommunication device according to claim 31, which is a cell phone device or a personal digital assistant device.

33. A display device having enhanced light transmission and/or reduction of glare from bright objects, comprising an AGAR optical material according to claim 2.

34. An optical device having enhanced light transmission and/or reduction of glare from bright objects, comprising an AGAR optical material according to claim 2.

35. A telecommunications device having enhanced light transmission and/or reduction of glare from bright objects, comprising an AGAR optical material according to claim 2.
